(19) United States
(12) Patent Application Publication
(10) Pub. No.: US 2016/0066495 A1
(43) Pub. Date: Mar. 10, 2016

(54) GARDENING DEVICES FOR EXTRACTING ROOTS AND RELATED METHODS

(71) Applicant: Huy Dao, Turlock, CA (US)

(72) Inventor: Huy Dao, Turlock, CA (US)

(21) Appl. No.: 14/847,423

(22) Filed: Sep. 8, 2015

Related U.S. Application Data
(60) Provisional application No. 62/046,593, filed on Sep. 5, 2014.

(51) Int. Cl. A01B 1/18

(52) U.S. Cl. CPC A01B 1/18

(57) ABSTRACT

A handheld gardening device is disclosed for removing a weed from a point below the ground surface. The handheld device has two extensions connected together and a removable about a pivot point. Each extension has an end head having a tip for penetrating the ground to extract the weed from a point below the ground surface.

### FIELD OF ART

The present invention is generally directed to gardening devices for combatting unwanted weeds and more particularly directed to handheld devices for extracting the roots of unwanted weeds and related methods.

### BACKGROUND

Unwanted weeds can grow just about anywhere, including in yards, cracks, and sidewalks. For the well-manicured yard of an unflagging gardener, it's an eyesore that cannot be tolerated. The current tool or method of choice for combatting unwanted weeds is weed killer, which is typically a herbicide spray that kills or inhibits root formation. It blocks photosynthesis and protein production, which interferes with growth and eventually kills the weed. Certain household products have also been used as weed killers, such as vinegar and salt. More commonly, gardeners simply pluck unwanted weeds from the ground by grabbing and pulling them near their bases. However, the bases or the roots of the pesky weeds can break leaving the plucked weeds to live another day.

### SUMMARY

Handheld devices are disclosed for extracting unwanted weeds from a point below a ground surface. The handheld devices may have end heads for digging into the ground and for gripping the root system of the weed to be plucked. The end heads can also grab the dirt formed around the root system at a point below the ground. This enables the user to pull the weed from a point or location below the ground surface to pull a substantial portion of the root system of the weed. Different end heads are disclosed for use with different dirt conditions and different gripping purposes. Some of the end heads can be used for multiple dirt conditions or purposes. Methods of making and of using the handheld devices are also disclosed.

Aspects of the present disclosure include a handheld gardening device for removing weed comprising a first extension coupled to a second extension and each extension comprising an end head and a handle for gripping by a hand; the two end heads each comprising at least one prong having a tip and a bottom connected to a respective one of the first extension and the second extension; and wherein the tips of the two prongs are insertable into the ground to remove weed from a point below a ground surface.

The gardening device wherein the end head of the first extension can comprise two prongs with a gap in between and the end head of the second extension can comprise a single prong aligned to the gap of the first extension when the first extension and the second extension are brought together.

The gardening device wherein the end head of the first extension can comprise two prongs with a gap in between and wherein each prong of the two prongs can comprise an outside edge and an inside edge and wherein at least one of the two edges comprises a jagged edge.

The gardening device wherein the end head of the first extension can comprise two prongs with a gap in between and wherein each prong of the two prongs can comprise a plurality of openings.

The gardening device wherein at least one prong of the second extension can comprise two outside edges and wherein at least one of the two outside edges can comprise a jagged edge.

The gardening device wherein each handle can comprise a grip ring.

The gardening device wherein the end head of the first extension can comprise an enlarged head comprising a V-shaped edge comprising an arrow.

The gardening device can further comprise an elongated channel.

The gardening device wherein each end head can comprise one or more ribs.

The gardening device wherein each end head can comprise at least two prongs.

A further aspect of the present disclosure includes a method for removing weed using a handheld gardening device. The method for removing weed can comprise: pushing two end heads into the ground such that at least one tip of each of the two end heads are below a ground surface and the two end heads are spaced from one another by a first distance; applying pressure to two handles of the handheld gardening device about a pivot to bias the two end heads toward one another to directly or indirectly grip at least part of a root system of the weed; and extracting the weed and the at least part of the root system from a point below the ground surface; wherein each end head has the at least one tip and a bottom connected to a base, which is connected to a body of an extension having one of the two handles and a pivot point, and wherein the bottom is larger in girth than the at least one tip.

The method wherein the two end heads can each comprise two tips and two prongs and a gap therebetween.

The method wherein one of the two end heads comprises two prongs with a gap therebetween and the other one of the two end heads comprises a single prong aligned to the gap.

The method wherein the weed can comprise a stem and wherein the weed can be extracted from the ground without touching the stem.

The method wherein the two handles can each comprise a grip ring.

Method of manufacturing a handheld gardening device described herein.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a schematic perspective view of a device in accordance with aspects of the present disclosure for pruning weeds.

FIG. 2 is an alternative pluck end of the device of FIG. 1 for use to prune weeds.

FIG. 3 is another alternative pluck end of the device of FIG. 1 for use to prune weeds.

FIG. 4 is another alternative pluck end of the device of FIG. 1 for use to prune weeds.

FIG. 5 is another alternative pluck end of the device of FIG. 1 for use to prune weeds.

FIG. 6 is another alternative pluck end of the device of FIG. 1 for use to prune weeds.

FIG. 7 is another alternative pluck end of the device of FIG. 1 for use to prune weeds.

FIG. 8 is a schematic side view of the handheld pruning device of FIG. 1 penetrating the ground to extract a weed from a point below the ground.

### DETAILED DESCRIPTION

The detailed description set forth below in connection with the appended drawings is intended as a description of the presently preferred embodiments of gardening devices and related methods provided in accordance with aspects of the present disclosure and are not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

With reference now to FIG. 1, a perspective view of a handle held or gardening device 100 provided in accordance with aspects of the present disclosure is shown. The device 100 comprises a first extension 102 attached to a second extension 104. Each extension 102, 104 comprises a body 106, a handle 108 comprising a grip ring 110, and an end head 112. The handle 108 may include cushioning pads or gripping pads. For example, the handle, such as the two grip rings, may incorporate plastic or an outer rubber material to provide cushion or gripping. As shown, the first extension 102 and the second extension 104 are attached to one another 116 using convention means, such as a bore 113 and a fastener 116. When connected, the first and second extensions 102, 104 can pivot relative to one another about a pivot point 114 at the fastener 116, similar to a common hand-held scissor. Although the two grip rings 110 are shown with closed loops, the loops can be open, such as having a gap. The two grip rings 100 can be identical or similar or noticeably different, such as one with a closed loop and the other with a gap of different sizes or two different shaped closed loops. One grip ring can also be round and the other generally elongated. The grip rings 100 can also be sized for left-handed or right-handed use and can have contoured surfaces accordingly to accommodate the left palm or the right palm. Thus, when the gardening device 100 is said to be movable by grabbing and manipulating the handles 108, it is understood to involve or include any appendages connected to the handles 108, such as the grip rings 110, for moving the two end heads 112, as further discussed below.

The device 100 has a length measured from the tip of at least one of the two head ends 112 and the opposite tip of at least one of the two grip rings 110. The two head ends 112 together define a plucking or active end 118 for use to prune the roots or to extract the roots, as further discussed below. Each head end 112 has a tip 120 and a base 122, which extends from the body 106. In an example, the head end 112 is integrally formed with the body 106, such as being casted with the body. In another example, the head end 112 is mechanically attached to the body 106, such as by threaded engagement. The length from the tip 120 to the base 122 of each head end 112 is sufficiently sized to penetrate below the ground to grip at least part of the root system of an unwanted weed from a point below the ground to extract the weed at its roots. In some examples, the length from the tip 120 to the base 122 of each head end 112 is at least 0.5 inch. In an exemplary embodiment, the length is about 0.5 inch to about 4.0 inches with about 0.5 inch to about 2.5 inches being more preferred. The length of the body 106 from the base 122 to the pivot point 114 at the fastener 116 is about 1 inch to about 5 inches. In other examples, the length of the body 106 can be longer than 5 inches, such as 6 to 12 inches. The length of the two handles 108 and the two grip rings 110 are sized and shaped to efficiently operate the gardening device 100 with the overall length of the two bodies 106 and the two head ends 112 to provide ample leverage for extracting weeds.

The device 100 may be made from durable metal material, such as stainless steel, carbon steel, alloys, and the likes, which can be cleaned, abused, and capable of repeated use. In an alternative embodiment, the device 100 is made from a durable rigid plastic, such as from a PEEK material, polycarbonate, and other sufficiently rigid plastics. The device can be made for one time use as well as for re-use.

As shown, the two end heads 112 are each shaped as a pitch fork comprising two prongs 130, 130 and a gap 134 in between. In the example shown, the gap 134 is generally rectangular in shape having an apex near the base of the two prongs 130. In other examples, the gap 134 has a different shape, such as being trapezoid or rectangular in shape. In some examples, one of the two end heads 112 only has a single prong that generally aligns with the gap 134 of the corresponding two-prong end head. Each prong 130 has a tip 136 and a bottom 138. The two bottoms 138 of the two prongs 130 are joined at the base 122 of the end head 112. Each bottom is generally round, slightly egg-shaped, oval, square, polygonal, elliptical or irregular in cross-section. Each tip 136 is generally pointed to facilitate penetrating the ground. In some example, the tip 136 is sharpened to a fine point, of about 1.5 mm. In other examples, the tip is generally larger in diameter, from about 2 mm to about 15 mm so as to be less sharp. In still other examples, the tip 136 is flattened, similar to a blunt knife edge. The end head 112 is preferably curved or slightly arcuate so that when two end heads 112 come together, they form a gap, cavity or pocket in between for extracting or plucking a weed from a point below the ground surface, as further discussed below.

With reference now to FIG. 2, an alternative end head 112 in accordance with aspects of the present devices, systems, and methods is shown. The end head 112 shown has two prongs 130 and is useable as an alternative to the end head 112 of FIG. 1. As shown, each prong 130 comprises a tip 136 and a bottom 138, an outside edge 144 and an inside edge 146. In the present example, the inside edge 146 is not smooth or continuous, such as been shaped or having jagged edges. The outside edge 144 is smooth but can be shaped or can include jagged edges. The end head 112 is preferably curved or slightly arcuate so that when two end heads 112 come together, they form a gap, cavity or pocket in between for surrounding the weed or root system to pluck. In other examples, the two end heads 112 of a gardening device employing the end head shape shown of FIG. 2 are somewhat flat as the gap or space for accommodating the weed and/or dirt can be by simply maintaining the two end heads spaced apart. Thus, the end heads 112 can either directly or indirectly grip the root system from below the ground surface by compressive pressure generated at the end heads squeezing directly or indirectly on the root system. This aspect is true for other end heads discussed elsewhere herein. The pressure can be generated by squeezing two handles 108 of a gardening device 100 together.

With reference now to FIG. 3, an alternative end head 112 in accordance with further aspects of the present devices, systems, and methods is shown. The end head 112 shown has a single prong 130 and is useable as an alternative to the end head 112 of FIG. 1. As shown, the prong 130 comprises a tip 136 and a bottom 138, and two outside edges 144. In the present example, the two outside edges 144 are not smooth or continuous, such as been shaped or having jagged edges. In still other examples, one outside edge is smooth and the other outside edge is not smooth. The end head 112 is preferably curved or slightly arcuate so that when two end heads 112 come together, they form a gap, cavity or pocket in between for surrounding the weed or root system to pluck.

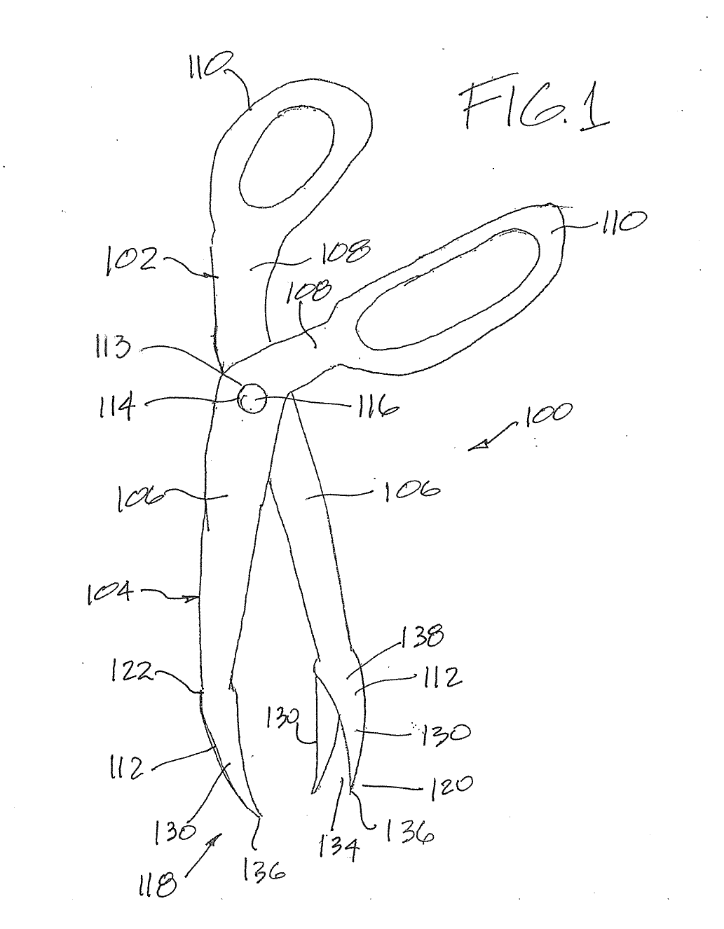

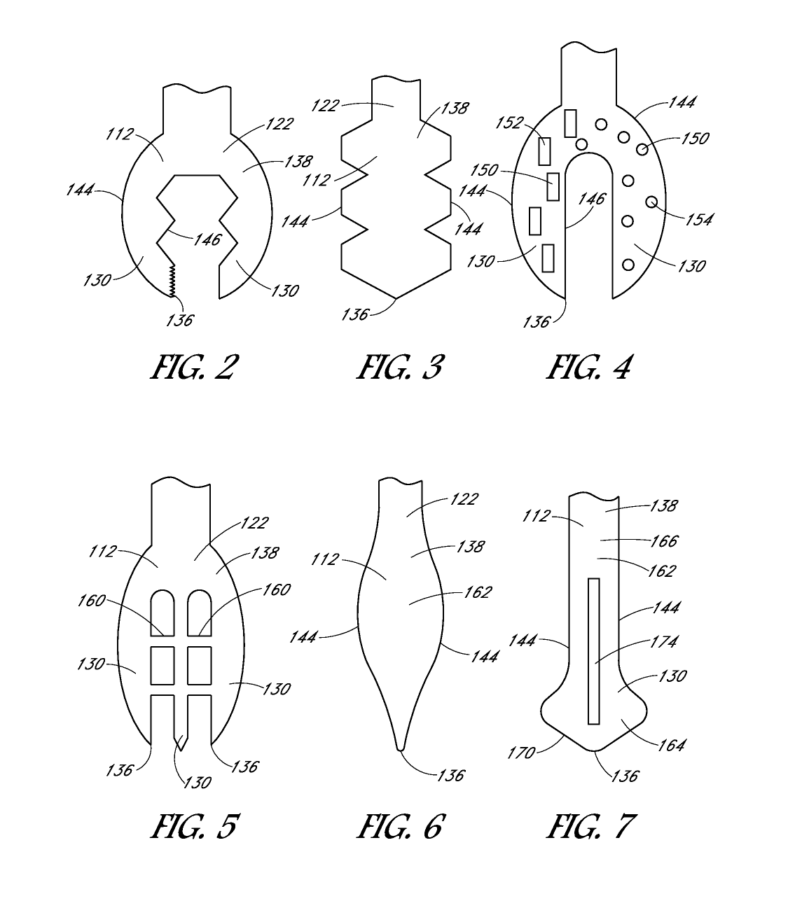

With reference now to FIG. 4, an alternative end head 112 in accordance with aspects of the present devices, systems, and methods is shown. The end head 112 shown has two prongs 130 and is useable as an alternative to the end head 112 of FIG. 1. As shown, each prong 130 comprises a tip 136 and a bottom 138, an outside edge 144 and an inside edge 146. In the present example, the inside edge and the outside edge are both smooth. However, either or both edges can be shaped, such as being jagged or include teeth. In the present example, a plurality of openings 150 is provided. The openings can have a number of different shapes, including polygonal 152 or round 154. In other examples, the openings can have different shapes, such as irregular shapes. The openings can also be uniform or similarly shaped or have different shapes. The end head 112 is preferably curved or slightly arcuate so that when two end heads 112 come together, they form a gap, cavity or pocket in between for surrounding the weed or root system to pluck.

With reference now to FIG. 5, an alternative end head 112 in accordance with aspects of the present devices, systems, and methods is shown. The end head 112 shown has three prongs 130 and is useable as an alternative to the end head 112 of FIG. 1. As shown, the two outside prongs 130 each comprises a tip 136 and a bottom 138, an outside edge 144 and an inside edge 146. The middle prong 130 has two inside edges as the two edges are located centrally of the two outside prongs. In the present example, the edges are smooth. However, either or both inside and outside edges can be shaped, such as being jagged or include teeth. In the present example, a plurality of ribs 160 is provided to connect the middle prong to the two outside prongs for support. In other examples, by increasing the girth of the prongs and/or using a stronger material, the ribs can be eliminated. The end head 112 is preferably curved or slightly arcuate so that when two end heads 112 come together, they form a gap, cavity or pocket in between for surrounding the weed or root system to pluck.

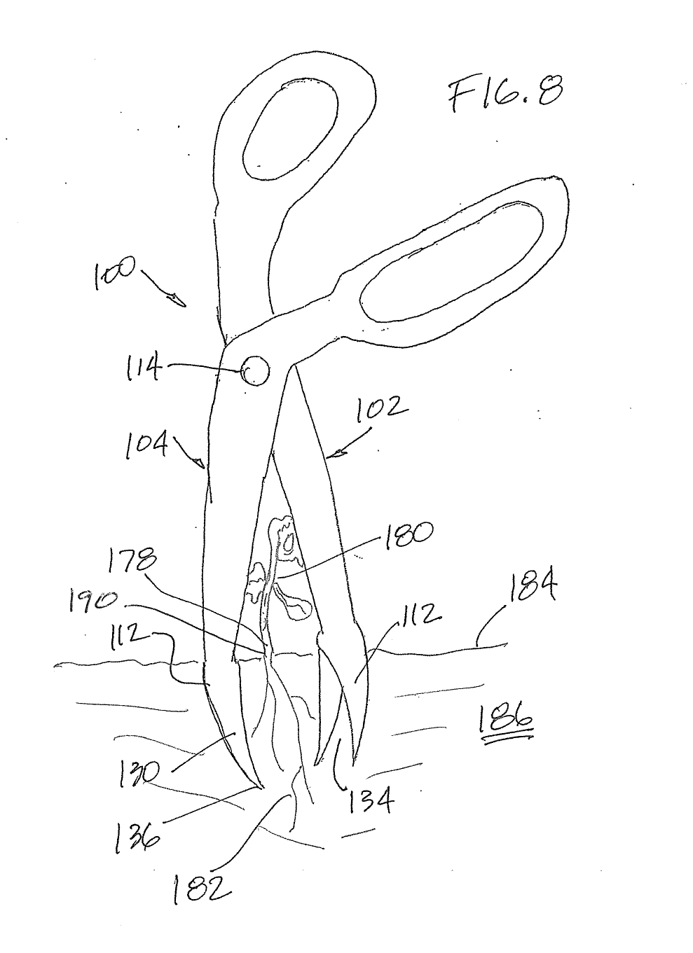

With reference now to FIG. 6, an alternative end head 112 in accordance with further aspects of the present devices, systems, and methods is shown. The end head 112 shown has a single prong 130 and is useable as an alternative to the end head 112 of FIG. 1. As shown, the prong 130 comprises a tip 136 and a bottom 138, and two outside edges 144. In the present example, the two outside edges are smooth. In other examples, one outside edge is smooth and the other outside edge is not smooth. The end head has a body section 162 that is enlarged such that it is wider than the width at the bottom 138 of the prong. The end head 112 is preferably curved or slightly arcuate so that when two end heads 112 come together, they form a gap, cavity or pocket in between for surrounding the weed or root system to pluck.

With reference now to FIG. 7, an alternative end head 112 in accordance with further aspects of the present devices, systems, and methods is shown. The end head 112 shown has a single prong 130 and is useable as an alternative to the end head 112 of FIG. 1. As shown, the prong 130 comprises a tip 136 and a bottom 138, and two outside edges 144. In the present example, the two outside edges are smooth. In other examples, one outside edge is smooth and the other outside edge is not smooth. The end head has a body section 162 having an enlarged tip section 164, near the tip 136, which has a width that is wider than the bottom body section 166. The enlarged tip section 164 has a generally V-shaped edge 170 resembling an arrow. A channel 174 is optionally incorporated with the body 162. The end head 112 is preferably curved or slightly arcuate so that when two end heads 112 come together, they form a gap, cavity or pocket in between for surrounding the weed or root system to pluck.

The gardening device 100 may incorporate any of the end heads 112 discussed with reference to FIGS. 1-7. In some examples, the two end heads 112 on the handheld device 100 are the same. In other example, the two end heads are different, such as having different shapes, configurations or designs. For example, the handheld device 100 may incorporate the end head 112 of FIG. 2 and the end head of FIG. 3, used together on the same handheld device, one on each end of the two extensions 102, 104.

Aspects of the present disclosure include methods for using the gardening device 100 and for manufacturing or making the handheld device 100.

FIG. 8 is a schematic view depicting the gardening device 100 in use to extract or remove a weed 180 having a root system 182 grown below the ground surface 184. The handheld device 100 may be used by forcing at least part of the two head ends 112 into the ground 186 and below the ground surface 184. The weed 180 and the stem 178 should be aligned with the end heads 112 so that most if not all of the weed and the stem 178 are located between the two extensions 102, 104 of the handheld device. Using the handle 108 and the gripping rings 110, the end heads 112 are moved together to encompass the root system 182 of the weed 180. Access dirt is permitted to escape through the gaps 134 on the two end heads 112 and between the two end heads. The handheld device 100 can be removed from the ground while holding onto the handles to pull the rood system 182 out from the ground. Thus, the handheld device 100 is understood to be configured to remove the weed 180 from a point below the ground surface 184. Further, when using the gardening device 100 of the present disclosure to remove a weed 180, the stem 178 of the weed 180 does not have to be grabbed or touched and the weed is less likely to break at the base 190 of the stem 178, near the ground surface 184.

Although limited embodiments of decompression instruments or devices and their components have been specifically described and illustrated herein, many modifications and variations will be apparent to those skilled in the art. Accordingly, it is to be understood that the decompression instruments or devices and their components constructed according to principles of the disclosed device, system, and method may be embodied other than as specifically described herein. The disclosure is also defined in the following claims.

What is claimed is:

1. A handheld gardening device for removing weed comprising a first extension coupled to a second extension and each extension comprising an end head and a handle for gripping by a hand; the two end heads each comprising at least one prong having a tip and a bottom connected to a respective one of the first extension and the second extension; and wherein the tips of the two prongs are insertable into the ground to remove weed from a point below a ground surface.

2. The gardening device of claim 1, wherein the end head of the first extension comprises two prongs with a gap in between and the end head of the second extension has a single prong aligned to the gap of the first extension when the first extension and the second extension are brought together.

3. The gardening device of claim 1, wherein the end head of the first extension comprises two prongs with a gap in between and wherein each prong of the two prongs comprises an outside edge and an inside edge and wherein at least one of the two edges comprises a jagged edge.

4. The gardening device of claim 1, wherein the end head of the first extension comprises two prongs with a gap in between and wherein each prong of the two prongs comprises a plurality of openings.

5. The gardening device of claim 1, wherein at least one prong of the second extension comprises two outside edges and wherein at least one of the two outside edges comprises a jagged edge.

6. The gardening device of claim 1, wherein each handle comprises a grip ring.

7. The gardening device of claim 6, wherein the end head of the first extension comprises an enlarged head comprising a V-shaped edge comprising an arrow.

8. The gardening device of claim 7, further comprising an elongated channel.

9. The gardening device of claim 1, wherein each end head comprises one or more ribs.

10. The gardening device of claim 9, wherein each end head comprises at least two prongs.

11. A method for removing weed using a handheld gardening device comprising:
pushing two end heads into the ground such that at least one tip of each of the two end heads are below a ground surface and the two end heads are spaced from one another by a first distance;
applying pressure to two handles of the handheld gardening device about a pivot to bias the two end heads toward one another to directly or indirectly grip at least part of a root system of the weed; and
extracting the weed and the at least part of the root system from a point below the ground surface;
wherein each end head has the at least one tip and a bottom connected to a base, which is connected to a body of an extension having one of the two handles and a pivot point, and wherein the bottom is larger in girth than the at least one tip.

12. The method of claim 11, wherein the two end heads each comprises two tips and two prongs and a gap therebetween.

13. The method of claim 11, wherein one of the two end heads comprises two prongs with a gap therebetween and the other one of the two end heads comprises a single prong aligned to the gap.

14. The method of claim 11, wherein the weed comprises a stem and wherein the weed is extracted from the ground without touching the stem.

15. The method of claim 11, wherein the two handles each comprises a grip ring.
